(19) United States
(12) Patent Application Publication
(10) Pub. No.: US 2008/0295868 A1
(43) Pub. Date: Dec. 4, 2008

(54) Manufacturing method of a semiconductor device and substrate cleaning apparatus

(75) Inventors: Naoto Nakamura, Toyama-shi (JP); Takeshi Taniguchi, Imizu-shi (JP)

Correspondence Address: OLIFF & BERRIDGE, PLC, P.O. BOX 320850, ALEXANDRIA, VA, 22320-4850, US

(73) Assignee: HITACHI KOKUSAI ELECTRIC INC., TOKYO (JP)

(21) Appl. No.: 12/155,388

(22) Filed: Jun. 3, 2008

(30) Foreign Application Priority Data
Jun. 4, 2007 (JP) 2007-147693
May 19, 2008 (JP) 2008-130598

(51) Int. Cl. B08B 3/04; B08B 13/00

(52) U.S. Cl. 134/28; 134/56 R

(57) ABSTRACT

A method of manufacturing a semiconductor device which has a cleaning process for cleaning a surface of a substrate while rotating the substrate. The cleaning process includes the steps of cleaning the substrate surface by supplying a cleaning liquid to the substrate; rinsing the cleaned substrate surface by supplying a rinse liquid containing pure water to the substrate; and drying the rinsed substrate. In the rinsing step, HF is added to the rinse liquid.

### BACKGROUND OF THE INVENTION

1. Field of the Invention

The present invention relates to a manufacturing method of a semiconductor device and a substrate cleaning apparatus.

2. Description of the Related Art

Among known substrate cleaning apparatus is a single-wafer spin substrate cleaning apparatus. In this type of substrate cleaning apparatus (e.g., the one disclosed in JP-A-2002-164316), first, a substrate surface is cleaned by supplying diluted hydrofluoric acid (DHF), for example, to it while rotating the substrate. Then, remaining DHF is rinsed off the substrate surface by supplying rinse water which is pure water to the substrate surface while rotating the substrate. Finally, remaining rinse water is spun off the substrate surface by rotating the substrate at high speed in a state that the supply of the rinse water is stopped, whereby the substrate is dried.

The above-described method of drying a substrate by spinning remaining rinse water off the substrate surface by rotating the substrate at high speed is called “spin drying.” More specifically, in the spin drying, water is spun off by centrifugal force that is produced by rotation and a remaining, small amount of water is removed by drying in a nitrogen atmosphere. Another drying method called Rotagoni drying is known in which vapor of IPA (Isopropyl alcohol) is supplied to the center side from a rinse water supply unit and rinse water is replaced by IPA.

The present inventors have found that the above-described spin drying may destroy patterns on a substrate surface. This is considered due to high surface tension of wafer. The inventors have also found that watermarks may occur on a substrate surface. On the other hand, the Rogotani drying is now not used for mass production because difficulties in setting conditions that relate to the substrate rotation, the supply of IPA vapor, etc.

### SUMMARY OF THE INVENTION

An object of the present invention is to provide a manufacturing method of a semiconductor device and a substrate cleaning apparatus capable of preventing destruction of patterns on a substrate surface and occurrence of watermarks.

One aspect of the invention provides a manufacturing method of a semiconductor device having a cleaning process for cleaning a surface of a substrate while rotating the substrate, the cleaning process comprising the steps of cleaning the substrate surface by supplying a cleaning liquid to the substrate; rinsing the cleaned substrate surface by supplying a rinse liquid containing pure water to the substrate; and drying the rinsed substrate, wherein the rinsing step comprises adding HF to the rinse liquid.

Another aspect of the invention provides a substrate cleaning apparatus comprising a holding tool that holds a substrate; a rotation mechanism that rotates the holding tool; a supply system that supplies a cleaning liquid, a rinse liquid containing pure water, and HF to the substrate; and a controller that controls the rotation mechanism and the supply system so that while the holding tool is rotated and the substrate is thereby rotated, the cleaning liquid is supplied to the substrate and a surface of the substrate is thereby cleaned, the rinse liquid to which HF is added is supplied to the substrate and the cleaned substrate surface is thereby rinsed, and then the substrate is dried.

The invention can prevent destruction of patterns on a substrate surface and occurrence of watermarks and thereby increase the yield of a semiconductor device.

### BRIEF DESCRIPTION OF THE DRAWINGS

FIG. 1 is a sectional view of a substrate cleaning apparatus according to a first embodiment of the present invention;

FIG. 2 is a side view of the substrate cleaning apparatus according to the first embodiment of the invention and a substrate transfer machine;

FIG. 3 is a flowchart of a control process of a controller in the first embodiment of the invention;

FIGS. 4A and 4B are a plan view and a side view, respectively, of the substrate cleaning apparatus executing a DHF cleaning step in the first embodiment of the invention;

FIGS. 5A and 5B are a plan view and a side view, respectively, of the substrate cleaning apparatus executing a rinsing step in the first embodiment of the invention;

FIGS. 6A and 6B are a plan view and a side view, respectively, of the substrate cleaning apparatus executing a replacing step in the first embodiment of the invention;

FIGS. 7A and 7B are a plan view and a side view, respectively, of the substrate cleaning apparatus executing a drying step in the first embodiment of the invention;

FIG. 8 is a sectional view of a substrate cleaning apparatus according to a second embodiment of the invention;

FIG. 9 is a sectional view of part of a substrate cleaning apparatus according to a modification of the second embodiment of the invention;

FIGS. 10A-11D are flowcharts showing cleaning processes according to the first and second embodiments and their modifications; and

FIG. 11 shows experimental results of the cleaning processes of FIGS. 10A-10D, respectively.

### DETAILED DESCRIPTION OF THE INVENTION

Embodiments of the present invention will be hereinafter described with reference to the drawings.

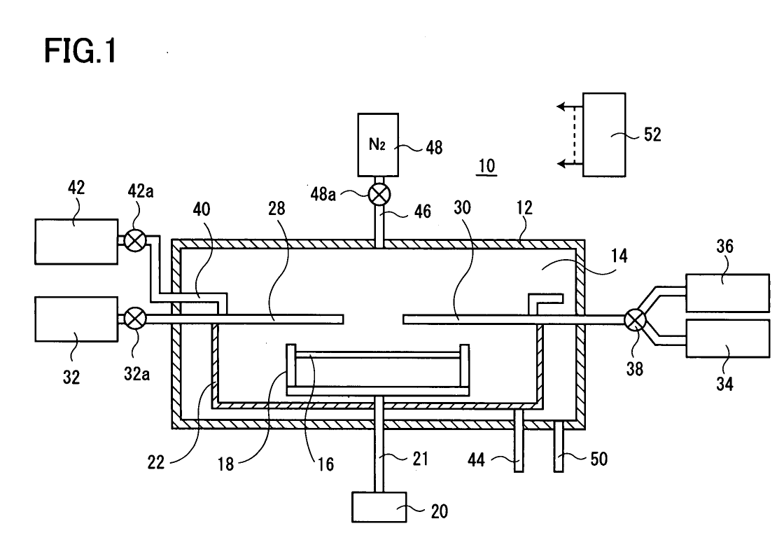

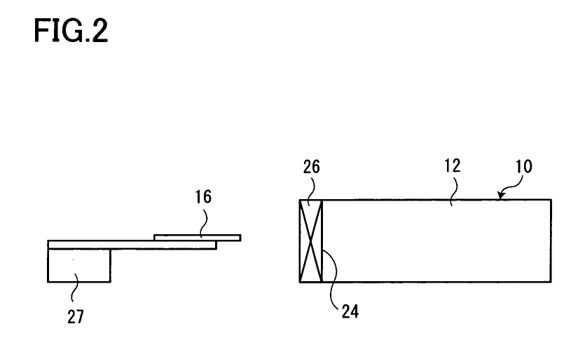

FIGS. 1 and 2 show a substrate cleaning apparatus 10 according to a first embodiment of the invention. The substrate cleaning apparatus 10 has a cleaning apparatus body 12 which forms a cleaning chamber 14 inside. A holding tool 18 for holding a substrate 16 such as a semiconductor wafer horizontally is disposed in the cleaning chamber 14. The holding tool 18 is connected to a rotation mechanism 20 such as a motor via a rotary shaft 21, whereby the substrate 16 can be rotated by the rotation mechanism 20 in a state that it is held horizontally.

The holding tool 18 is surrounded by a cover 22. As described later, the cover 22 is to receive a liquid chemical that is spun off the substrate 16 when it is rotated being held by the holding tool 18.

As shown in FIG. 2, a substrate carrying-in/out opening 24 is formed in a side wall of the cleaning apparatus body 12. Equipped with a gate valve 26, the substrate carrying-in/out opening 24 is opened or closed by the gate valve 26. A substrate transfer machine 27 is provided which transfers a substrate 16 to the holding tool 18 through the substrate carrying-in/out opening 24.

A first nozzle 28 and a second nozzle 30 are inserted in the cleaning chamber 14. Each of the first nozzle 28 and the second nozzle 30 extends horizontally in such a manner that its tip is located close to the center of the substrate 16 that is held by the holding tool 18. The first nozzle 28 is connected to a cleaning liquid supply unit 32 for supplying a cleaning liquid (e.g., DHF) via a control valve 32a for controlling the supply of the cleaning liquid. Cleaning liquid is supplied to the center of the substrate 16 from the first nozzle 28. The second nozzle 30 is connected to a rinse liquid supply unit 34 for supplying a rinse liquid which is pure water and a replacement liquid supply unit 36 for supplying a replacement liquid via a control valve 38 for controlling the supply of the rinse liquid and the replacement liquid. Rinse liquid or replacement liquid is supplied to the center of the substrate 16 from the second nozzle 30. Therefore, the first nozzle 28, the cleaning liquid supply unit 32, and the control valve 32a mainly constitute a cleaning liquid supply system, the second nozzle 30, the rinse liquid supply unit 34, and the control valve 38 mainly constitute a rinse liquid supply system, and the second nozzle 30, the replacement liquid supply unit 36, and the control valve 38 mainly constitute a replacement liquid supply system. The cleaning liquid supply system, the rinse liquid supply system, and the replacement liquid supply system constitute a supply system.

The replacement liquid is a liquid that has lower surface tension than the rinse liquid, that is, pure water, and can be mixed with the rinse liquid. For example, the replacement liquid is one of methanol, ethanol, isopropyl alcohol (IPA), n-propyl alcohol, ethylene glycol, and 2-methyl-2-propanol, a mixture thereof, or a dilution of one of them (diluted with pure water). The replacement liquid also functions as a rinse liquid. Therefore, a notation may be employed in which the pure water rinse liquid is called a first rinse liquid, the replacement liquid is called a second rinse liquid, and they are generically referred to simply as a rinse liquid.

A water supply member 40 has an opening close to the top portion of the inside surface of the cover 22 and the other end of the water supply member 40 is connected to a pure water supply unit 42 for supplying water which is pure water. The water supply member 40 can thus supply water to the inside surface of the cover 22. The water supply member 40 is equipped with a control valve 42a for controlling the supply of pure water. The rinse liquid supply unit 34 may also be used as the pure water supply unit 42.

A drainage pipe 44 for draining water from the cover 22 is connected to the bottom surface of the cover 22. The drainage pipe 44 extends to the outside of the substrate cleaning apparatus body 12.

A drying gas supply pipe 46 is connected to a top portion of the substrate cleaning apparatus body 12, and a drying gas supply unit 48 is connected to the other end of the drying gas supply pipe 46. The drying gas supply pipe 46 is provided with a control valve 48a for controlling the supply of a drying gas. An example of the drying gas is nitrogen (N₂). An exhaust pipe 50 for exhausting the drying gas is connected to a bottom portion of the substrate cleaning apparatus body 12.

A controller 52, which is a computer, controls the rotation of the holding tool 18 by the rotation mechanism 20, the opening and closing of the substrate carrying-in/out opening 24 by the gate valve 26, the carrying-in and out of a substrate 16 by the substrate transfer machine 27, the supply of DHF through the first nozzle 28 (controlled by the control valve 32a), the supply of rinse liquid or replacement liquid through the second nozzle 30 (controlled by the control valve 38), the supply of pure water through the water supply member 40 (controlled by the control valve 42a), the supply of nitrogen (N₂) through the drying gas supply pipe 46 (controlled by the control valve 48a), and other operations.

Next, a description will be made of a method for cleaning a substrate using the substrate cleaning apparatus 10 having the above configuration, which is one step of a semiconductor device manufacturing process.

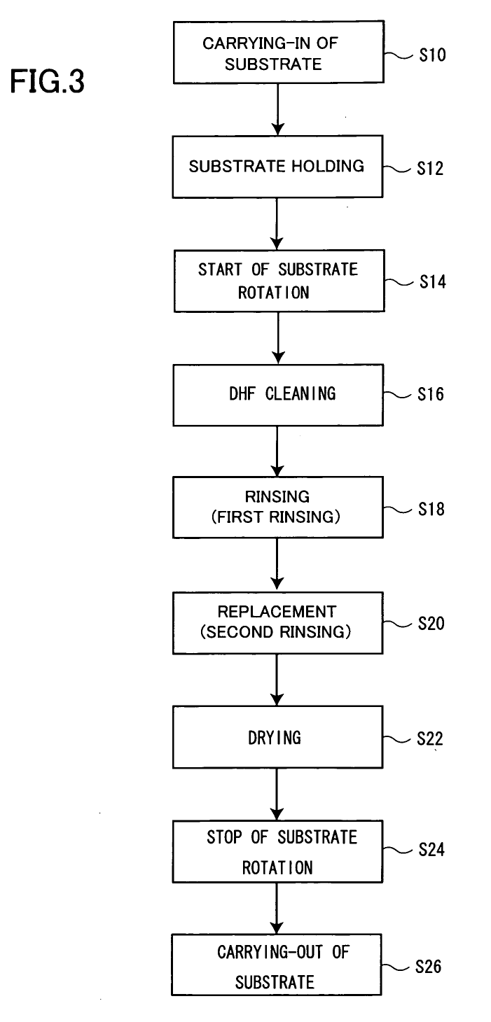

FIG. 3 is a flowchart of a control process of the controller 52. First, at step S10, the substrate carrying-in/out opening 24 is opened by the gate valve 26 and a substrate 16 on which patterns are formed is carried into the cleaning chamber 14 by the substrate transfer machine 27.

At step S12, the substrate 16 is held by (set in) the holding tool 18 by further controlling the substrate transfer machine 27 and the substrate carrying-in/out opening 24 is closed by the gate valve 26.

At step S14, rotation of the substrate 16 is started by rotating the holding tool 18 with the rotation mechanism 20 via the rotary shaft 21.

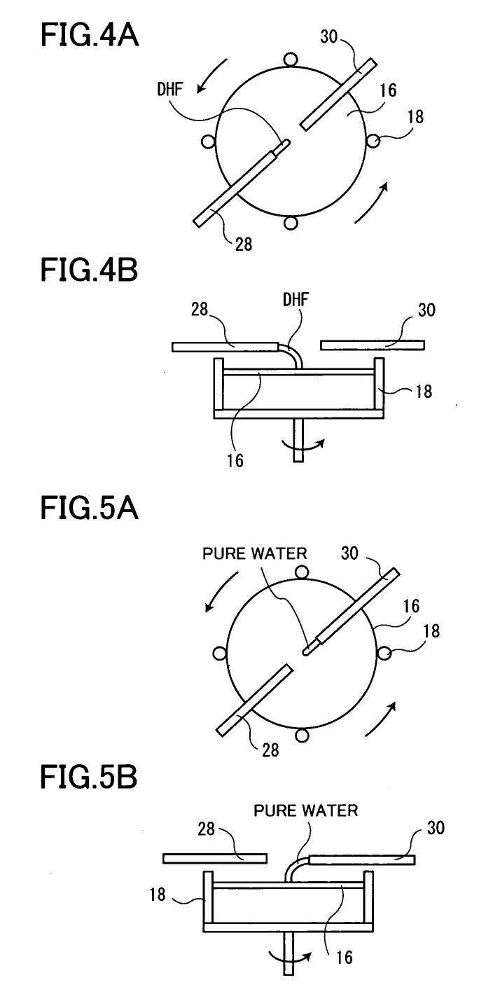

At step S16, as shown in FIGS. 4A and 4B, DHF is supplied toward the center of the substrate 16 from the first nozzle 28 while the substrate 16 is kept rotating, whereby the surface of the substrate 16 is cleaned.

At step S18, as shown in FIGS. 5A and 5B, while the substrate 16 is kept rotating, the supply of DHF from the first nozzle 28 is stopped, the rinse liquid supply side of the control valve 38 is opened and its replacement liquid supply side is closed, and pure water as rinse liquid (first rinse liquid) is supplied toward the center of the substrate 16 from the second nozzle 30, whereby remaining DHF is rinsed off the surface of the substrate 16.

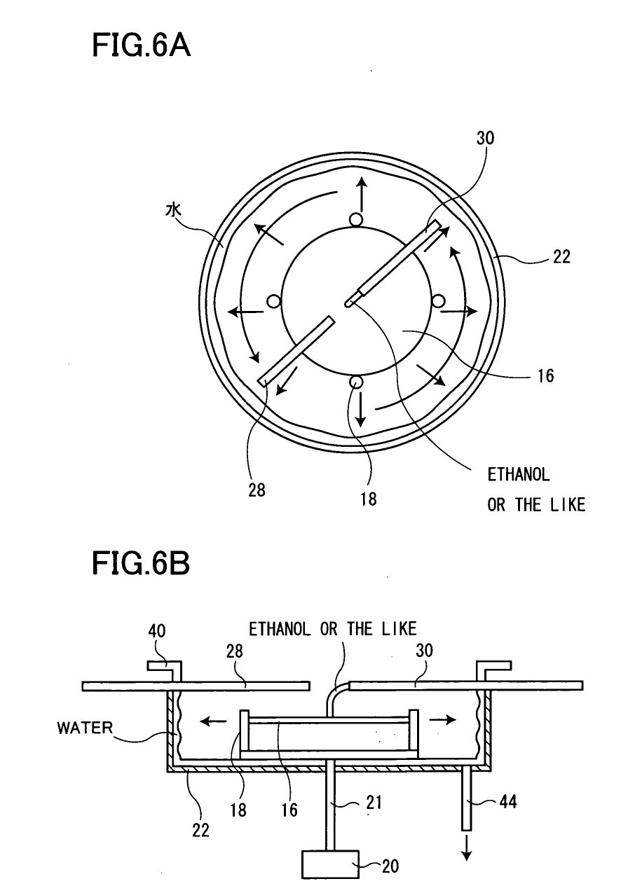

At step S20, while the substrate 16 is kept rotating, the rinse liquid supply side of the control valve 38 is closed gradually and its replacement liquid supply side is opened gradually, and ethanol or the like as replacement liquid (second rinse liquid) is supplied toward the center of the substrate 16 from the second nozzle 30 (see FIGS. 6A and 6B). The pure water on the substrate 16 is thereby replaced by ethanol or the like. If the replacement liquid can be mixed with water, it is not necessary to replace the rinse liquid completely; only part of the rinse liquid may be replaced by replacement liquid.

Furthermore, at step S20, water is supplied to the inside surface of the cover 22 through the water supply member 40. This reduces the risk of burning that may be caused by ethanol or the like that is spun off to the inside surface of the cover 22. The water that is supplied to the inside surface of the cover 22 is drained outside through the drainage pipe 44.

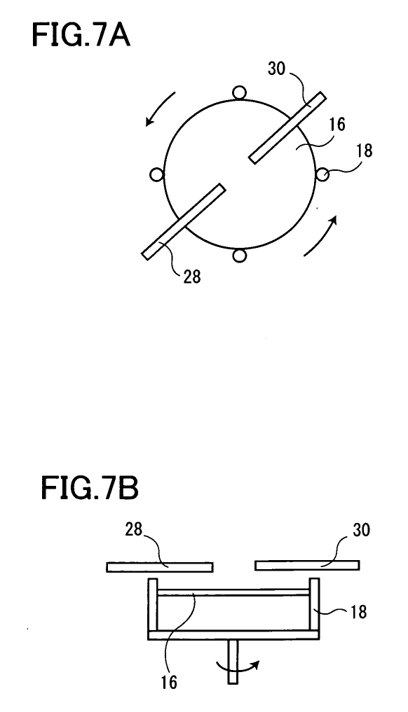

At step S22, as shown in FIGS. 7A and 7B, while the substrate 16 is kept rotating, the supply of replacement liquid (and rinse liquid) is stopped and remaining ethanol etc. is spun off the substrate 16 by centrifugal force. At step S22, N₂ as drying gas is supplied into the cleaning chamber 14 from the drying gas supply unit 48 via the drying gas supply pipe 46, whereby an N₂ atmosphere is formed in the cleaning chamber 14. The substrate 16 is dried in the N₂ atmosphere.

The supply of water to the inside surface of the cover 22 through the water supply member 40 may be performed only at step S20 (replacing step). Alternatively, to increasing the safety, it may be continued so as to be also performed at step S22 (drying step). That is, the supply of water to the inside surface of the cover 22 may be performed at least while ethanol or the like is spun off the substrate 16 to the cover 22.

At step S24, the rotation of the substrate is stopped by stopping the rotation of the support tool 18 by the rotation mechanism 20. The N₂ in the cleaning chamber 14 is exhausted.

At step S26, the substrate carrying-in/out opening 24 is opened by the gate valve 26 and the substrate 16 is carried out of the cleaning chamber 14 by the substrate transfer machine 27. Then, the substrate 16 is transported to another apparatus such as an epitaxial growth apparatus and subjected to such processing as film formation.

According to this embodiment, the substrate 16 is dried after the rinse liquid is replaced by the liquid such as alcohol that is lower in surface tension than the rinse liquid. Since the surface tension (22.55 mN/m (at 20° C.)) of ethanol, for example, is lower than the surface tension (72.75 mN/m (at 20° C.)) of water, if the rinse liquid is replaced completely by the replacement liquid, the force acting on the patterns on the surface of the substrate 16 is reduced to about ⅓. This makes it possible to prevent the patterns from being destroyed because of the surface tension. Furthermore, according to this embodiment, when the rinse liquid is replaced by alcohol or the like, organic materials on the surface of the substrate 16 can be removed through action of alcohol or the like. Still further, according to this embodiment, when the water on the surface of the substrate 16 is replaced by a flammable liquid chemical such as alcohol, water is supplied to the cover 22 which receives the liquid chemical that is spun off the rotating substrate 16. The risk of burning can thus be reduced.

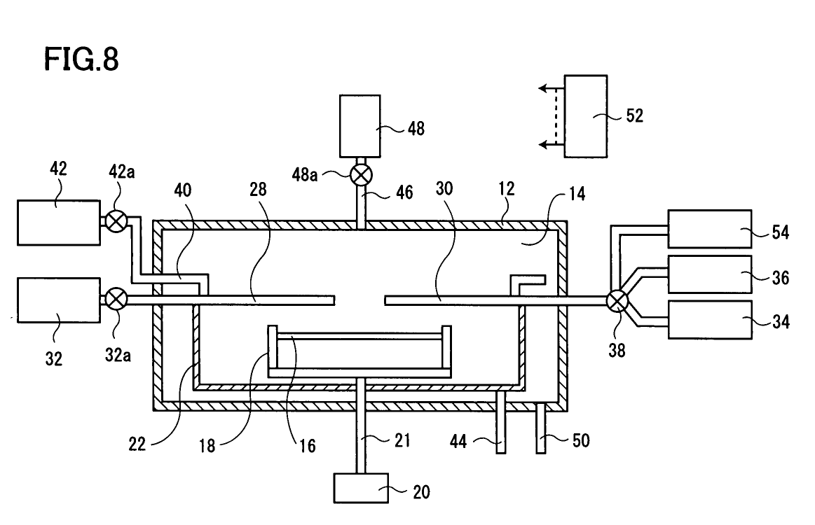

FIG. 8 shows a substrate cleaning apparatus 10′ according to a second embodiment of the invention. The second embodiment is different from the first embodiment in that a hydrogen fluoride (HF) supply unit 54 is connected to the second nozzle 30 via a control valve 38, that is, a hydrogen fluoride supply system is provided as an additional supply system. At the above-described step S20, a control is made so that HF is added to a final rinse liquid for replacing pure water with ethanol or the like. HF should be added at a very low concentration; it is preferable that the HF concentration in the final rinse liquid be 1 to 1,000 ppm.

The reason for adding HF to the final rinse liquid at a very low concentration is to prevent occurrence of watermarks without destroying patterns on the substrate 16 when the substrate 16 is dried. The watermark is a pattern that is formed in such a manner that impurities dissolved in a water droplet (e.g., dissolved silica) are left on the surface when the water droplet is vaporized. By adding HF to the final rinse liquid, impurities such as dissolved silica, which are a cause of watermarks, can be changed to substances having high vapor pressure. The substrate 16 can be dried without causing watermarks because the substances having high vapor pressure vaporize.

Incidentally, it is known that the concentration of dissolved silica in pure water is about 0.1 to 10 ppt or less. The current technology cannot prevent silica from remaining in pure water at the above level of concentration. In many cases, alcohol such as IPA is used being diluted with pure water. In this case, silica should remain at the above level of concentration in pure-water-diluted IPA, that is, an IPA solution. That is, when alcohol such as pure-water-diluted IPA is used as a replacement liquid, silica should be dissolved in a final rinse liquid.

Taking the concentration of dissolved silica into account, to remove the dissolved silica after being stabilized (i.e., changed to a material having high vapor pressure), it is necessary to add HF to the IPA solution at least at 1 to 1,000 ppm. If the HF concentration is lower than 1 ppm, the probability of contact between HF and silica is so low that the dissolved silica cannot be removed sufficiently. On the other hand, if the HF concentration is higher than 1,000 ppm, films formed on the surface of the substrate 16 are etched. In other words, as long as the HF concentration is within the range of 1 to 1,000 ppm, the dissolved silica can be removed sufficiently without etching films formed on the surface of the substrate 16.

If the drainage treatment is taken into account, it is preferable that the HF concentration be in a range of 1 to 10 ppm. As long as the HF concentration is within this range, the dissolved silica can be removed sufficiently without etching films formed on the surface of the substrate 16 and drainage treatment is made unnecessary.

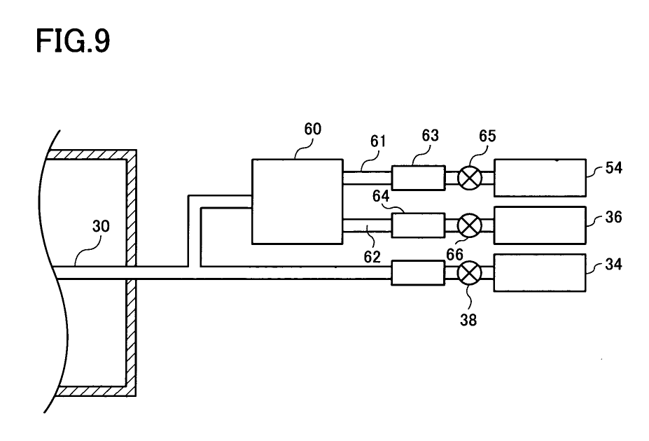

In this embodiment, the rinse liquid supply system (first rinse liquid supply system), the replacement liquid supply system (second rinse liquid supply system), and the HF supply system which are parts of the supply system may be arranged as shown in FIG. 9. In FIG. 9, the second nozzle 30 is connected to the rinse liquid supply unit 34 via a flow rate controller 67 and a control valve 38. A branch line branches off the second nozzle 30 upstream of the control valve 38 and is connected to a compounding device 60. The compounding device 60 is connected to the replacement liquid supply unit 36 via a pipe which is provided with a flow rate controller 64 and a valve 66. The compounding device 60 is also connected to the HF supply unit 54 via a pipe 61 which is provided with a flow rate controller 63 and a valve 65. The compounding device 60 adjusts the HF concentration in replacement liquid by compounding the replacement liquid and HF whose flow rates are controlled by the flow rate controllers 64 and 63, respectively. Forming the supply system in the above-described manner makes it possible to easily secure high controllability of the HF concentration in replacement liquid and to easily adjust the very low HF concentration.

Although HF is added in the second embodiment, the invention is not limited to such a case. Any material can be used that can change impurities that cause watermarks to substances having high vapor pressure. For example, hydrogen chloride (HCl) or aqueous ammonia (NH₄OH) may be used in place of HF.

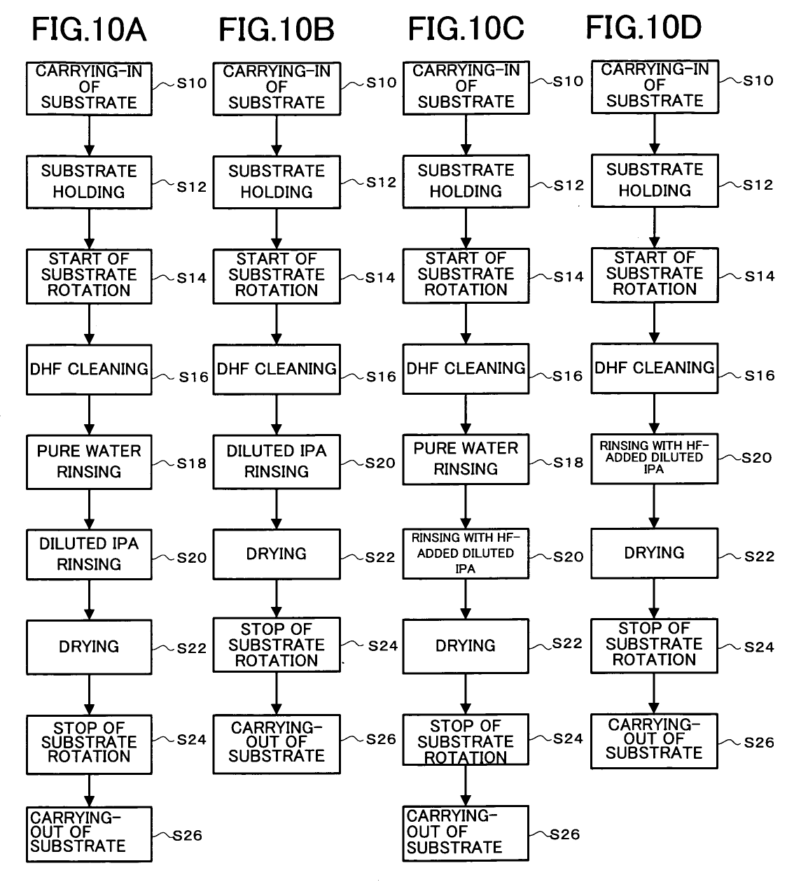

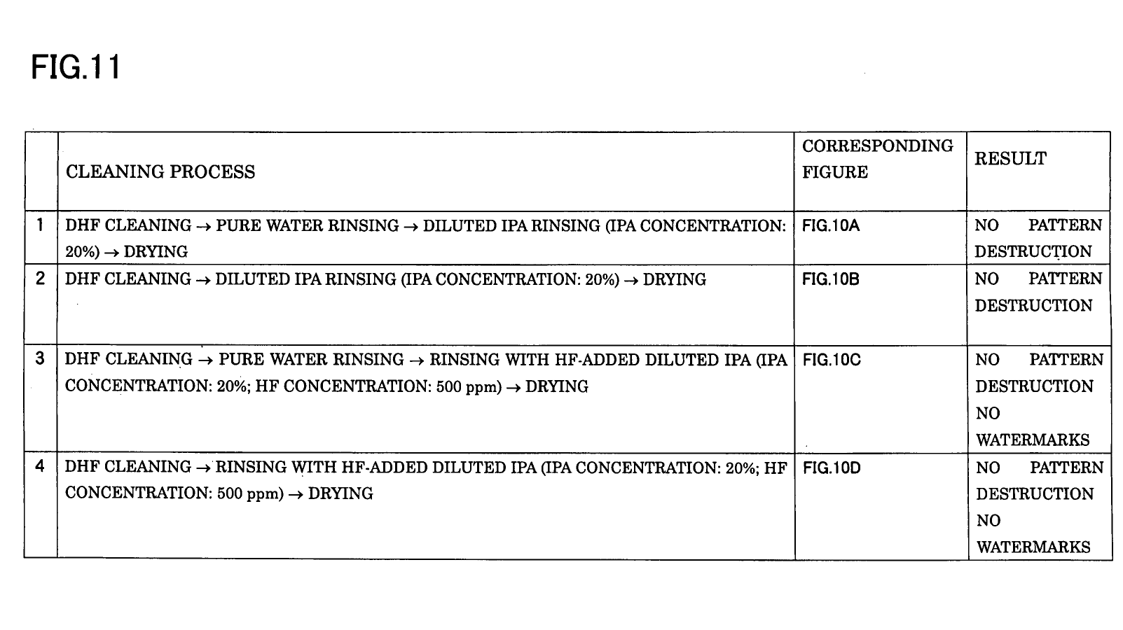

In the first and second embodiments, DHF cleaning is performed at step S16, pure water as a first rinse liquid is supplied to the substrate 16 at step S18, and ethanol or the like as a second rinse liquid is supplied to the substrate 16 at step S20. However, step S18 (rinsing with pure water) may be omitted. That is, after DHF cleaning, rinsing with a liquid chemical such as ethanol may be performed without performing rinsing with pure water. This will be described with reference to FIGS. 10A-10D. It is assumed that the liquid chemical used is pure-water-diluted IPA (hereinafter abbreviated as “diluted IPA”).

FIG. 10A is a flowchart showing a cleaning process corresponding to the one according to the first embodiment, and FIG. 10B is a flowchart showing a cleaning process in which step S18 (pure water rinsing) is removed from the cleaning process of FIG. 10A. FIG. 10C is a flowchart showing a cleaning process corresponding to the one according to the second embodiment, and FIG. 10D is a flowchart showing a cleaning process in which step S18 (pure water rinsing) is removed from the cleaning process of FIG. 10C. More specifically, FIG. 10A shows a process in which DHF cleaning, pure water rinsing, diluted IPA rinsing, and drying are performed in this order. FIG. 10B shows a process in which DHF cleaning, diluted IPA rinsing, and drying are performed in this order. FIG. 10C shows a process in which DHF cleaning, pure water rinsing, rinsing with HF-added diluted IPA, and drying are performed in this order. FIG. 10D shows a process in which DHF cleaning, rinsing with HF-added diluted IPA, and drying are performed in this order. Even the cleaning processes of FIGS. 10B and 10D which do not employ pure water rinsing can provide the same advantages as those of FIGS. 10A and 10C, respectively.

### EXAMPLES

Substrates on which patterns were formed were cleaned by the cleaning processes of FIGS. 10A-10D. The cleaning processes of FIGS. 10A and 10B were executed by using the substrate cleaning apparatus 10 according to the first embodiment, and the cleaning processes of FIGS. 10C and 10D were executed by using the substrate cleaning apparatus 10′ according to the second embodiment. In the processes of FIGS. 10A and 10B, the diluted IPA rinsing was performed by setting the IPA concentration at 20%. In the processes of FIGS. 10C and 10D, the rinsing with HF-added diluted IPA was performed by setting the IPA concentration and the HF concentration at 20% and 500 ppm, respectively.

FIG. 11 shows results. In the cleaning processes of FIGS. 10A and 10B, no patterns formed on the substrate 16 were destroyed. In the cleaning processes of FIGS. 10C and 10D, no patterns formed on the substrate 16 were destroyed and no watermarks occurred.

One aspect of the invention provides a manufacturing method of a semiconductor device having a cleaning process for cleaning a surface of a substrate while rotating the substrate, the cleaning process comprising the steps of cleaning the substrate surface by supplying a cleaning liquid to the substrate; rinsing the cleaned substrate surface by supplying a rinse liquid containing pure water to the substrate; and drying the rinsed substrate, wherein the rinsing step comprises adding HF to the rinse liquid.

It is preferable that the HF concentration in the rinse liquid be 1 to 1,000 ppm.

It is preferable that the HF concentration in the rinse liquid be 1 to 10 ppm.

It is preferable that the cleaning liquid contain HF and the HF concentration in the rinse liquid be lower than that in the cleaning liquid.

It is preferable that the rinse liquid contain one of methanol, ethanol, isopropyl alcohol, n-propyl alcohol, ethylene glycol, and 2-methyl-2-propanol or a mixture thereof.

It is preferable that a cover that receives the cleaning liquid or the rinse liquid that is spun off the substrate when the substrate is rotated be provided around the substrate, and that the manufacturing method further comprise the step of supplying pure water to a portion of the cover on which the rinse liquid splashes at least while the rinse liquid is spun off the substrate.

It is preferable that the rinsing step comprise the substeps of supplying a first rinse liquid containing pure water to the substrate; and supplying, to the substrate, a second rinse liquid containing pure water and one of methanol, ethanol, isopropyl alcohol, n-propyl alcohol, ethylene glycol, and 2-methyl-2-propanol or a mixture thereof and thereby replacing the first rinse liquid on the substrate surface with the second rinse liquid, and that the HF be added to the second rinse liquid.

It is preferable that the rinsing step comprise the substeps of supplying a first rinse liquid containing pure water to the substrate; and supplying, to the substrate, a second rinse liquid containing pure water and having lower surface tension than the first rinse liquid and thereby replacing the first rinse liquid on the substrate surface with the second rinse liquid, and that the HF be added to the second rinse liquid.

Another aspect of the invention provides a substrate cleaning apparatus comprising a holding tool that holds a substrate; a rotation mechanism that rotates the holding tool; a supply system that supplies a cleaning liquid, a rinse liquid containing pure water, and HF to the substrate; and a controller that controls the rotation mechanism and the supply system so that while the holding tool is rotated and the substrate is thereby rotated, the cleaning liquid is supplied to the substrate and a surface of the substrate is thereby cleaned, the rinse liquid to which HF is added is supplied to the substrate and the cleaned substrate surface is thereby rinsed, and then the substrate is dried.

It is preferable that the controller control the supply system so that the HF concentration in the rinse liquid becomes 1 to 1,000 ppm.

It is preferable that in rinsing the cleaned substrate surface the controller control the supply system so that a first rinse liquid containing pure water is supplied to the substrate, and then a second rinse liquid added with HF and containing pure water and one of methanol, ethanol, isopropyl alcohol, n-propyl alcohol, ethylene glycol, and 2-methyl-2-propanol or a mixture thereof is supplied to the substrate and the first rinse liquid on the substrate surface is thereby replaced by the second rinse liquid.

It is preferable that the substrate cleaning apparatus further comprise a cover that receives the cleaning liquid or the rinse liquid that is spun off the substrate when the substrate is rotated; and a water supply unit that supplies pure water to the cover, that the controller control the water supply unit so that pure water is supplied to a portion of the cover on which the rinse liquid splashes at least while the rinse liquid is spun off the substrate, and that the rinse liquid further contain one of methanol, ethanol, isopropyl alcohol, n-propyl alcohol, ethylene glycol, and 2-methyl-2-propanol or a mixture thereof.

Still another aspect of the invention provides a manufacturing method of a semiconductor device having a cleaning process for cleaning a surface of a substrate while rotating the substrate, the cleaning process comprising the steps of cleaning the substrate surface by supplying a cleaning liquid to the substrate; rinsing the cleaning liquid off the substrate surface by supplying a rinse liquid to the substrate; replacing at least part of the rinse liquid on the substrate surface with a liquid having lower surface tension than the rinse liquid by supplying the liquid to the substrate; and drying the substrate after the at least part of the rinse liquid on the substrate surface has been replaced by the liquid.

It is preferable that the liquid be one of methanol, ethanol, isopropyl alcohol, n-propyl alcohol, ethylene glycol, and 2-methyl-2-propanol or a mixture thereof.

Another aspect of the invention provides a substrate cleaning apparatus comprising a holding tool that holds a substrate; a rotation mechanism that rotates the holding tool; supply means that supplies a cleaning liquid, a rinse liquid, and a liquid having lower surface tension than the rinse liquid to the substrate; and a controller that controls the rotation mechanism and the supply means so that while the holding tool holding the substrate is rotated, the cleaning liquid is supplied to the substrate and a surface of the substrate is thereby cleaned, the rinse liquid is supplied to the substrate and the cleaning liquid on the substrate surface is thereby rinsed off, the liquid is supplied to the substrate and at least part of the rinse liquid on the substrate surface is thereby replaced by the liquid, and then the substrate is dried.

It is preferable that the substrate cleaning apparatus further comprise a cover that receives a liquid chemical that is spun off the substrate when the substrate is rotated together with the holding tool; and a water supply unit that supplies water to at least a portion of the cover on which the liquid chemical splashes, and that the controller controls the water supply unit so that water is supplied to the cover at least while the at least part of the rinse liquid is replaced by the liquid.

It is preferable that the substrate cleaning apparatus further comprise a cover that receives a liquid chemical that is spun off the substrate when the substrate is rotated together with the holding tool; and a water supply unit that supplies water to at least a portion of the cover on which the liquid chemical splashes, and that the controller controls the water supply unit so that water is supplied to the cover at least while the at least part of the rinse liquid is replaced by the liquid and the substrate is dried.

It is preferable that the substrate cleaning apparatus further comprise a cover that receives a liquid chemical that is spun off the substrate when the substrate is rotated together with the holding tool; and a water supply unit that supplies water to at least a portion of the cover on which the liquid chemical splashes, and that the controller controls the water supply unit so that water is supplied to the cover at least while the liquid is spun off the substrate.

Yet another aspect of the invention provides a substrate cleaning method having a cleaning process for cleaning a surface of a substrate while rotating the substrate, the cleaning process comprising the steps of cleaning the substrate surface by supplying a cleaning liquid to the substrate; rinsing the cleaning liquid off the substrate surface by supplying a rinse liquid to the substrate; replacing at least part of the rinse liquid on the substrate surface with a liquid having lower surface tension than the rinse liquid by supplying the liquid to the substrate; and drying the substrate after the at least part of the rinse liquid on the substrate surface has been replaced by the liquid.

It is preferable that the step of replacing at least part of the rinse liquid on the substrate surface with a liquid having lower surface tension than the rinse liquid by supplying the liquid to the substrate produce a final rinse liquid by adding HF to the liquid at a very low concentration.

It is preferable that the HF concentration in the final rinse liquid be lower than or equal to 1,000 ppm.

It is preferable that the HF concentration in the final rinse liquid be lower than or equal to 100 ppm.

It is preferable that the HF concentration in the final rinse liquid be lower than or equal to 10 ppm.

It is preferable that the HF concentration in the final rinse liquid be lower than or equal to 1 ppm.

It is preferable that HCl be added in place of HF.

It is preferable that NH₄OH be added in place of HF.

A further aspect of the invention provides a manufacturing method of a semiconductor device having a cleaning process for cleaning a surface of a substrate while rotating the substrate, the cleaning process comprising the steps of cleaning the substrate surface by supplying a cleaning liquid to the substrate; rinsing the cleaning liquid off the substrate surface by supplying a rinse liquid to which HF, HCl, or NH₄OH is added to the substrate; and drying the substrate.

What is claimed is:

1. A method of manufacturing a semiconductor device having a cleaning process for cleaning a surface of a substrate while rotating the substrate, the cleaning process comprising the steps of:
cleaning the substrate surface by supplying a cleaning liquid to the substrate;
rinsing the cleaned substrate surface by supplying a rinse liquid containing pure water to the substrate; and
drying the rinsed substrate,
wherein in the rinsing step HF is added to the rinse liquid.

2. The method of manufacturing a semiconductor device according to claim 1, wherein an HF concentration in the rinse liquid is 1 to 1,000 ppm.

3. The method of manufacturing a semiconductor device according to claim 1, wherein an HF concentration in the rinse liquid is 1 to 10 ppm.

4. The method of manufacturing a semiconductor device according to claim 1, wherein the cleaning liquid contains HF and an HF concentration in the rinse liquid is lower than that in the cleaning liquid.

5. The method of manufacturing a semiconductor device according to claim 1, wherein the rinse liquid contains one of methanol, ethanol, isopropyl alcohol, n-propyl alcohol, ethylene glycol, and 2-methyl-2-propanol or a mixture thereof.

6. The method of manufacturing a semiconductor device according to claim 5, wherein a cover that receives the cleaning liquid or the rinse liquid that is spun off the substrate when the substrate is rotated is provided around the substrate, and wherein pure water is supplied to a portion of the cover on which the rinse liquid splashes at least while the rinse liquid is spun off the substrate.

7. The method of manufacturing a semiconductor device according to claim 1, wherein the rinsing step comprises the substeps of:
supplying a first rinse liquid containing pure water to the substrate; and
supplying, to the substrate, a second rinse liquid containing pure water and one of methanol, ethanol, isopropyl alcohol, n-propyl alcohol, ethylene glycol, and 2-methyl-2-propanol or a mixture thereof and thereby replacing the first rinse liquid on the substrate surface with the second rinse liquid, and
wherein the HF is added to the second rinse liquid.

8. The method of manufacturing a semiconductor device according to claim 1, wherein the rinsing step comprises the substeps of:
supplying a first rinse liquid containing pure water to the substrate; and
supplying, to the substrate, a second rinse liquid containing pure water and having lower surface tension than the first rinse liquid and thereby replacing the first rinse liquid on the substrate surface with the second rinse liquid, and
wherein the HF is added to the second rinse liquid.

9. A substrate cleaning apparatus comprising:
a holding tool that holds a substrate;
a rotation mechanism that rotates the holding tool;
a supply system that supplies a cleaning liquid, a rinse liquid containing pure water, and HF to the substrate; and
a controller that controls the rotation mechanism and the supply system so that while the holding tool is rotated and the substrate is thereby rotated, the cleaning liquid is supplied to the substrate and a surface of the substrate is thereby cleaned, the rinse liquid to which HF is added is supplied to the substrate and the cleaned substrate surface is thereby rinsed, and then the substrate is dried.

10. The substrate cleaning apparatus according to claim 9, wherein the controller controls the supply system so that an HF concentration in the rinse liquid becomes 1 to 1,000 ppm.

11. The substrate cleaning apparatus according to claim 9, wherein in rinsing the cleaned substrate surface the controller controls the supply system so that a first rinse liquid containing pure water is supplied to the substrate, and then a second rinse liquid added with HF and containing pure water and one of methanol, ethanol, isopropyl alcohol, n-propyl alcohol, ethylene glycol, and 2-methyl-2-propanol or a mixture thereof is supplied to the substrate and the first rinse liquid on the substrate surface is thereby replaced by the second rinse liquid.

12. The substrate cleaning apparatus according to claim 9, further comprising:
a cover that receives the cleaning liquid or the rinse liquid that is spun off the substrate when the substrate is rotated; and
a water supply unit that supplies pure water to the cover,
wherein the controller controls the water supply unit so that pure water is supplied to a portion of the cover on which the rinse liquid splashes at least while the rinse liquid is spun off the substrate, and
wherein the rinse liquid contains one of methanol, ethanol, isopropyl alcohol, n-propyl alcohol, ethylene glycol, and 2-methyl-2-propanol or a mixture thereof.
